(19) United States
(12) Patent Application Publication
(10) Pub. No.: US 2009/0060300 A1
(43) Pub. Date: Mar. 5, 2009

(54) Method and apparatus for image alignment

(75) Inventors: Huzefa Neemuchwala, Mountain View, CA (US); Akira Hasegawa, Saratoga, CA (US); Kunlong Gu, Belmont, CA (US)

Correspondence Address: BIRCH STEWART KOLASCH & BIRCH, PO BOX 747, FALLS CHURCH, VA, 22040-0747, US

(73) Assignee: Fujifilm Corporation

(21) Appl. No.: 11/896,247

(22) Filed: Aug. 30, 2007

(51) Int. Cl. G06K 9/00

(52) U.S. Cl. 382/128

(57) ABSTRACT

Methods and apparatuses align breast images. The method according to one embodiment accesses digital image data representing a first breast image including a left breast, and a second breast image including a right breast; removes from the first and second breast images artifacts not related to the left and right breasts; and aligns the left and right breasts using a similarity measure between the first and second breast images, the similarity measure depending on a relative position of the first and second breast images.

### BACKGROUND OF THE INVENTION

1. Field of the Invention

The present invention relates to a digital image processing technique, and more particularly to a method and apparatus for processing and aligning images.

2. Description of the Related Art

Identification of abnormal structures in medical images is important in many fields of medicine. For example, identification of abnormal structures in mammograms is important and useful for a prompt diagnosis of medical problems of breasts.

One way to identify abnormal structures in breasts is to compare mammograms of left and right breasts of a person. Bilateral mammograms are routinely acquired in hospitals, to screen for breast cancer or other breast abnormalities. A radiologist views the mammograms of the left and right breasts together, to establish a baseline for the mammographic parenchyma of the patient, and to observe differences between the left and right breasts. Because of positioning differences, however, the left and right mammogram views are often displaced. Consequently, one breast image is displaced with respect to the other breast image when the left and right view mammograms are viewed together.

Alignment of the left and right breast mammograms is a non-trivial task, due to shape variations between left and right breasts, unusual or abnormal breast shapes, lighting variations in medical images taken at different times, patient positioning differences with respect to the mammography machine, variability of breast borders, unclear areas, non-uniform background regions, tags, labels, or scratches present in mammography images, etc.

One known method to align left and right breast mammograms is described in U.S. Pat. No. 7,046, 860, titled “Method for Simultaneous Body Part Display”, by E. Soubelet, S. Bothorel, and S. L. Muller. With the technique described in this patent, left and right breast mammogram images are aligned by defining a substantially rectangular region of interest on each image, where the region of interest in each image is a minimum surface area that covers the breast. The regions of interest are then aligned by first comparing vertical dimensions of the regions of interest for each image. If the vertical dimensions of the left and right mammograms are identical, a vertical alignment of an upper or lower edge of the regions of interest is performed. If the vertical dimensions are different, an optimization criterion, which is a function of relative image position, is calculated, and the images are aligned while maximizing the optimization criterion. With this technique, however, comparison of vertical dimensions of regions of interest from each image introduces alignment errors when, for example, one breast is markedly different from the other breast.

Disclosed embodiments of this application address these and other issues by clearing the background in breast images, and aligning breast images using image similarity measures. Various similarity measures, such as cross-correlation and mutual information, are used to align breast images based on an optimized similarity value. Alignment of breast images can be efficiently performed by calculating cross-correlation using, for example, the Fast Fourier Transform. Image noise, artifacts, lead-markers, tags, etc., are removed from the background of breast images prior to alignment, to obtain accurate alignment results. The techniques described in the present invention can align pairs of mammography images irrespective of pose/view.

### SUMMARY OF THE INVENTION

The present invention is directed to methods and apparatuses for aligning breast images. According to a first aspect of the present invention, an image processing method comprises: accessing digital image data representing a first breast image including a left breast, and a second breast image including a right breast; removing from the first and second breast images artifacts not related to the left and right breasts; and aligning the left and right breasts using a similarity measure between the first and second breast images, the similarity measure depending on a relative position of the first and second breast images.

According to a second aspect of the present invention, an image processing method comprises: accessing digital image data representing a first breast image including a left breast, and a second breast image including a right breast; setting background pixels in the first and second breast images to a substantially uniform pixel intensity value; and aligning the left and right breasts using a similarity measure between the first and second breast images, the similarity measure depending on a relative position of the first and second breast images.

According to a third aspect of the present invention, an image processing apparatus comprises: an image data input unit for accessing digital image data representing a first breast image including a left breast, and a second breast image including a right breast; an image preprocessing unit for setting background pixels in the first and second breast images to a substantially uniform pixel intensity value; and an image alignment unit for aligning the left and right breasts using a similarity measure between the first and second breast images, the similarity measure depending on a relative position of the first and second breast images.

### BRIEF DESCRIPTION OF THE DRAWINGS

Further aspects and advantages of the present invention will become apparent upon reading the following detailed description in conjunction with the accompanying drawings, in which:

FIG. 1 is a general block diagram of a system including an image processing unit for image alignment according to an embodiment of the present invention;

FIG. 2 is a block diagram illustrating in more detail aspects of the image processing unit for image alignment according to an embodiment of the present invention;

FIG. 3 is a flow diagram illustrating operations performed by an image processing unit for image alignment according to an embodiment of the present invention illustrated in FIG. 2;

FIG. 4 is a flow diagram illustrating operations performed by an image operations unit included in an image processing unit for image alignment according to an embodiment of the present invention illustrated in FIG. 2;

FIG. 5 is a flow diagram illustrating operations performed by an image similarity unit included in an image processing unit for image alignment according to an embodiment of the present invention illustrated in FIG. 2;

FIG. 6A is a flow diagram illustrating operations performed by an image similarity unit using cross-correlation calculated via the Fast Fourier Transform according to an embodiment of the present invention illustrated in FIG. 5;

FIG. 6B is a flow diagram illustrating details of operations performed by an image similarity unit using cross-correlation calculated via the Fast Fourier Transform according to an embodiment of the present invention illustrated in FIG. 5;

FIG. 7 is a flow diagram illustrating operations performed by an image alignment unit included in an image processing unit for image alignment according to an embodiment of the present invention illustrated in FIG. 2;

FIG. 8A illustrates a pair of exemplary left and right mammogram images not aligned to each other;

FIG. 8B illustrates the correlation coefficient for the images in FIG. 8A, for various relative displacements between the images according to an embodiment of the present invention illustrated in FIG. 5;

FIG. 8C illustrates the left and right mammogram images from FIG. 8A aligned to each other to maximize the correlation coefficient illustrated in FIG. 8B; and

FIG. 8D illustrates exemplary alignment results for left and right mammogram images according to an embodiment of the present invention illustrated in FIG. 2.

### DETAILED DESCRIPTION

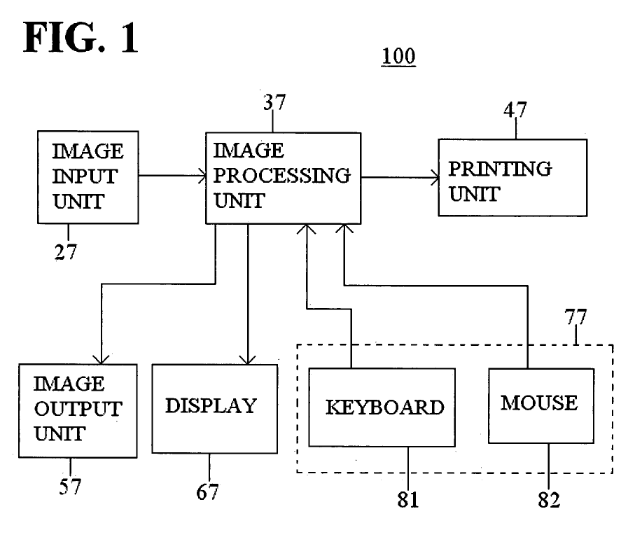

Aspects of the invention are more specifically set forth in the accompanying description with reference to the appended figures. FIG. 1 is a general block diagram of a system including an image processing unit for image alignment according to an embodiment of the present invention. The system 100 illustrated in FIG. 1 includes the following components: an image input unit 27; an image processing unit 37; a display 67; an image output unit 57; a user input unit 77; and a printing unit 47. Operation of the system 100 in FIG. 1 will become apparent from the following discussion.

The image input unit 27 provides digital image data. The digital image data may be medical images, such as, for example, mammography images. Image input unit 27 may be one or more of any number of devices providing digital image data derived from a radiological film, a diagnostic image, a digital system, etc. Such an input device may be, for example, a scanner for scanning images recorded on a film; a digital camera; a digital mammography machine; a recording medium such as a CD-R, a floppy disk, a USB drive, etc.; a database system which stores images; a network connection; an image processing system that outputs digital data, such as a computer application that processes images; etc.

The image processing unit 37 receives digital image data from the image input unit 27 and performs alignment of images in a manner discussed in detail below. A user, e.g., a radiology specialist at a medical facility, may view the output of image processing unit 37, via display 67 and may input commands to the image processing unit 37 via the user input unit 77. In the embodiment illustrated in FIG. 1, the user input unit 77 includes a keyboard 81 and a mouse 82, but other conventional input devices can also be used.

In addition to performing image alignment in accordance with embodiments of the present invention, the image processing unit 37 may perform additional image processing functions in accordance with commands received from the user input unit 77. The printing unit 47 receives the output of the image processing unit 37 and generates a hard copy of the processed image data. In addition or as an alternative to generating a hard copy of the output of the image processing unit 37, the processed image data may be returned as an image file, e.g., via a portable recording medium or via a network (not shown). The output of image processing unit 37 may also be sent to image output unit 57 that performs further operations on image data for various purposes. The image output unit 57 may be a module that performs further processing of the image data, a database that collects and compares images, etc.

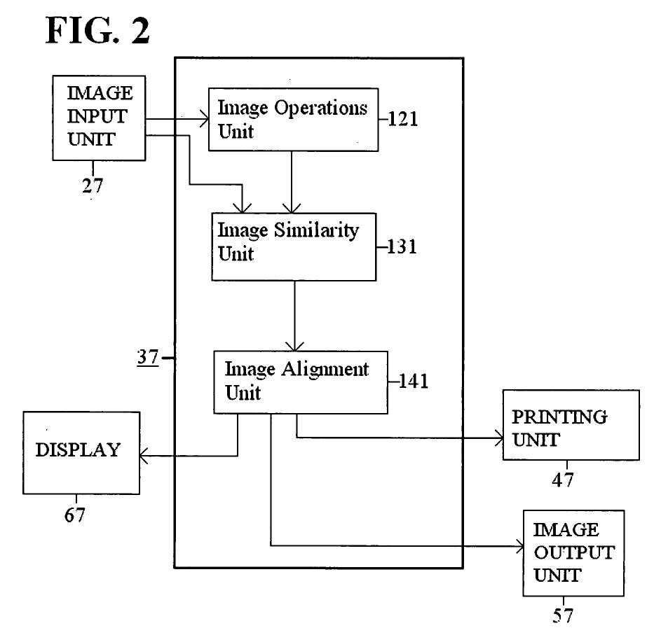

FIG. 2 is a block diagram illustrating in more detail aspects of the image processing unit 37 for image alignment according to an embodiment of the present invention. As shown in FIG. 2, the image processing unit 37 according to this embodiment includes: an image operations unit 121; an image similarity unit 131; and an image alignment unit 141. Although the various components of FIG. 2 are illustrated as discrete elements, such an illustration is for ease of explanation and it should be recognized that certain operations of the various components may be performed by the same physical device, e.g., by one or more microprocessors.

Generally, the arrangement of elements for the image processing unit 37 illustrated in FIG. 2 performs preprocessing and preparation of digital image data, calculation of similarity measures between images from digital image data, and alignment of images based on similarity measures. Operation of image processing unit 37 will be next described in the context of mammography images, for alignment of images of left and right breasts.

Image operations unit 121 receives mammography images from image input unit 27, and may perform preprocessing and preparation operations on the mammography images. Preprocessing and preparation operations performed by image operations unit 121 may include resizing, cropping, compression, etc., that change size and/or appearance of the mammography images.

Image operations unit 121 sends preprocessed mammography images to image similarity unit 131. Image similarity unit 131 may receive mammography images directly from image input unit 27 as well. Image similarity unit 131 calculates similarity measures between breast images, and sends the results of image similarity calculations to image alignment unit 141.

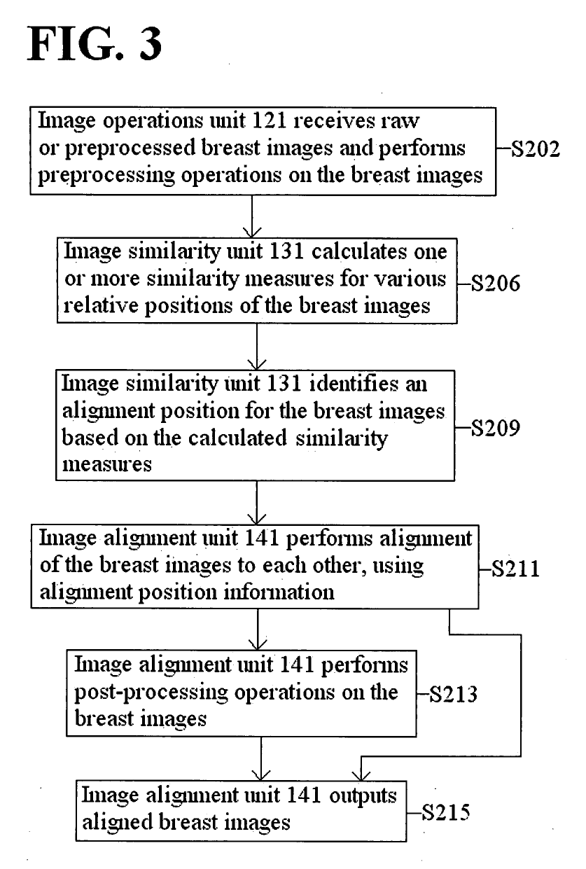

Image alignment unit 141 receives breast images and similarity calculations for the breast images, and aligns the breast images with respect to each other using the similarity calculations. Finally, image alignment unit 141 outputs aligned breast images, or alignment information for the breast images. The output of image alignment unit 141 may be sent to image output unit 57, printing unit 47, and/or display 67. Operation of the components included in the image processing unit 37 illustrated in FIG. 2 will be next described with reference to FIGS. 3-8D.

Image operations unit 121, image similarity unit 131, and image alignment unit 141 are software systems/applications. Image operations unit 121, image similarity unit 131, and image alignment unit 141 may also be purpose built hardware such as FPGA, ASIC, etc.

FIG. 3 is a flow diagram illustrating operations performed by an image processing unit 37 for image alignment according to an embodiment of the present invention illustrated in FIG. 2. Image operations unit 121 receives raw or preprocessed breast images from image input unit 27, and performs preprocessing operations on the breast images (S202). The breast images may be a pair of left and right breast images. Preprocessing operations may include resizing, smoothening, compression, etc.

Image similarity unit 131 receives raw or preprocessed breast images from image operations unit 121 or from image input unit 27, and calculates one or more similarity measures for various relative positions of the breast images (S206). An alignment position for the breast images is identified based on the calculated similarity measures (S209). Information for the alignment position is sent to image alignment unit 141. Image alignment unit 141 then performs alignment of the breast images to each other, using alignment position information (S211). Image alignment unit 141 may also perform post-processing operations on the breast images (S213). Post-processing operations may include resizing, supersampling of images to higher/original resolution, etc.

Image alignment unit 141 outputs aligned breast images (S215). The output of image alignment unit 141 may be sent to image output unit 57, printing unit 47, and/or display 67.

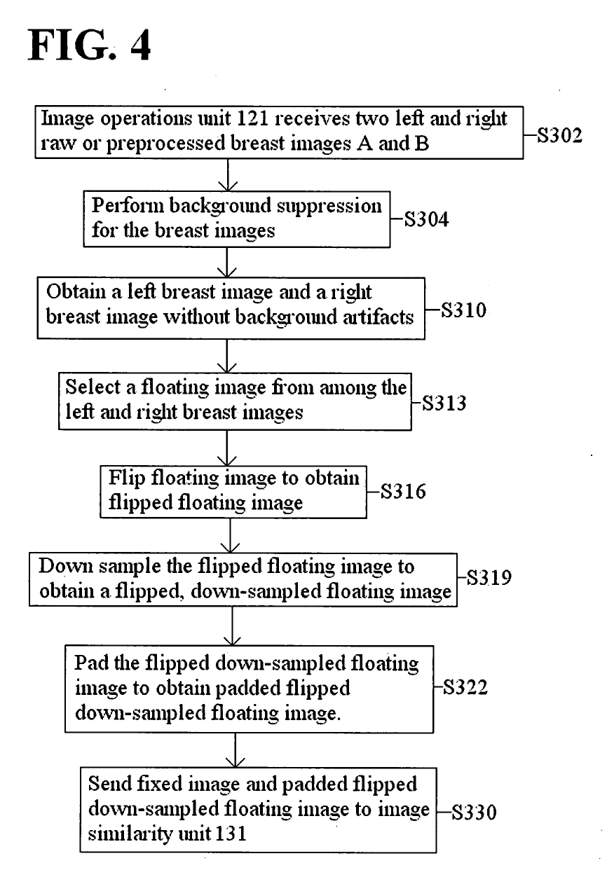

FIG. 4 is a flow diagram illustrating operations performed by an image operations unit 121 included in an image processing unit 37 for image alignment according to an embodiment of the present invention illustrated in FIG. 2. The flow diagram in FIG. 4 illustrates exemplary details of step S202 from FIG. 3.

Image operations unit 121 receives two raw or preprocessed breast images A and B from image input unit 27 (S302). The breast images A and B represent images of the left and right breasts of a person. Bilateral mammograms are routinely acquired from patients in hospitals, to diagnose or screen for breast cancer or other abnormalities. Mammograms may be acquired in top-down (CC) or left-right (ML) views. Examples of left and right mammogram views are MLL (medio-lateral left) and MLR (medio-lateral right), CCL (cranio-caudal left) and CCR (cranio-caudal right), LMLO (left medio-lateral oblique) and RMLO (right medio-lateral oblique), etc. The mammograms of the left and right breasts will be subsequently viewed together, by a radiologist.

Image operations unit 121 performs background suppression for the breast images A and B (S304). Mammography images typically show breasts on a background. The background may contain artifacts, tags, markers, etc., indicating the view of the mammogram image acquisition, the patient ID, etc. Background interference contributes with noise to the alignment algorithm and may produce sub-optimal results. A large position marker (a led marker which specifies the view and patient position) for example, could throw off the alignment of breast images. Hence, the position marker should be removed.

Tags, markers, and other background artifacts/obstructions are suppressed by image operations unit 121 in step S304. To perform background and artifact suppression for a mammography image, image operations unit 121 detects the breast and masks the background so that background pixels have similar intensity. To perform background and artifact suppression for a mammography image, image operations unit 121 may also detect the background without detecting the breast, and then mask the background.

In one exemplary embodiment, the background is masked so that all background pixels have intensity zero.

Image operations unit 121 may perform background and artifact suppression for breast images using methods described in the US Patent Application titled “Method and Apparatus for Breast Border Detection”, application Ser. No. 11/366,495, by Daniel Russakoff and Akira Hasegawa, filed on Mar. 3, 2006, the entire contents of which are hereby incorporated by reference. With the techniques described in the “Method and Apparatus for Breast Border Detection” patent application, image pixels that belong to the breast are detected. For this purpose, pixels in a breast image are represented in a multi-dimensional space, such as a 4-dimensional space, with x-locations of pixels, y-locations of pixels, intensity value of pixels, and distance of pixels to a reference point. Instead of x-locations of pixels and y-locations of pixels, other Euclidean spatial coordinates may be used. For example, a combination of x-location and y-location coordinates, polar coordinates, cylindrical coordinates, etc., may be used. Other higher or lower order dimensional representations of pixels, encoding more that 4 or fewer that 4 pixel properties/parameters, may also be used.

K-means clustering of pixels is then run in the multi-dimensional pixel representation space, to obtain clusters for a breast image. In one exemplary implementation, K-means clustering divides the group of 4-dimensional pixel representations into clusters such that a distance metric relative to the centroids of the clusters is minimized. The positions of the cluster centroids are determined and the value of the distance metric to be minimized is calculated. Some of the 4-dimensional pixel representations are then reassigned to different clusters, to minimize the distance metric. New cluster centroids are determined, and the distance metric to be minimized is again calculated. Reassignment for 4-dimensional pixel representations is performed to refine the clusters, i.e., to minimize the distance metric relative to the centroids of the clusters. Convergence in the K-means clustering method is achieved when no pixel changes its cluster membership.

In the context of clustering, the first two dimensions in the 4-dimensional pixel representations, namely the Euclidean spatial coordinates, enforce a spatial relationship of pixels that belong to the same cluster. Hence, pixels that belong to the same cluster have similar Euclidean spatial coordinates values in the 4-dimensional space spanned by the pixel representations. The third dimension in the 4-dimensional pixel representations, the intensity value of pixels, enforces the fact that pixels that belong to the same cluster are typically similar in intensity. Finally, the 4th dimension in the 4-dimensional pixel representations, the distance of pixels to a reference point, introduces a smoothness constraint about the reference point. The smoothness constraint relates to the fact that breast shapes typically vary smoothly about a reference point.

Cluster merging and connected components analysis are next performed using relative intensity measures, brightness pixel values, and cluster size, to identify a cluster corresponding to the breast in the breast image, as well as clusters not related to the breast, such as clusters that include image artifacts. Artifacts not related to the breast but connected to the breast are removed using a chain code, and the breast contour is joined up using linear approximations. With these techniques, non-uniform background regions, tags, labels, or scratches present in a breast image are removed.

Thresholds for breast pixel intensities, differences of pixel intensities, and/or breast pixel gradient intensities, etc., determined from empirical evidence from mammography images, may be used in clustering. Methods for determining such thresholds are described in the above listed US patent application “Method and Apparatus for Breast Border Detection”.

In an exemplary implementation, K-means clustering with K=4 clusters is performed, so that breast image pixels are placed in one of four clusters. In another exemplary implementation, K-means clustering with K=3 clusters is performed.

By using breast detection methods described in the US Patent Application titled “Method and Apparatus for Breast Border Detection”, pacemakers or implants are detected and incorporated into the breast cluster if their images superimpose with the breast image, or are rejected if their images are separate from the breast image.

Other versions of K-means clustering, other clustering methods, or other background suppression methods may also be used by image operations unit 121.

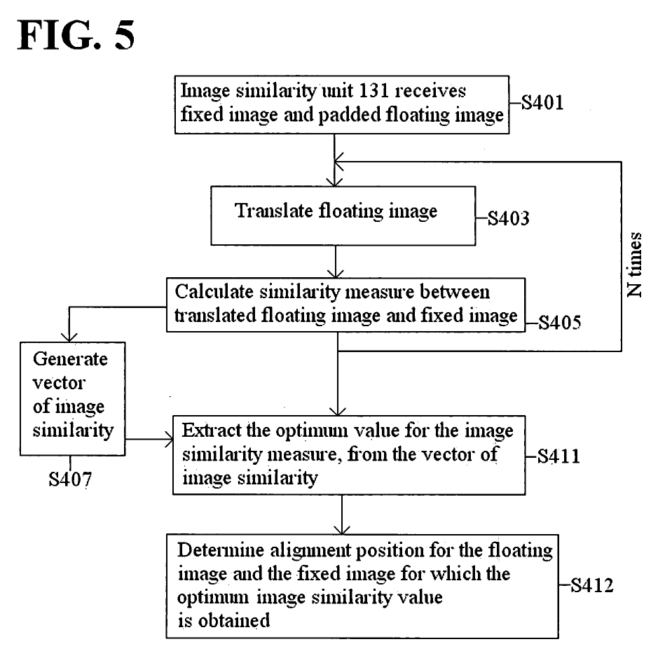

Image operations unit 121 hence obtains a left breast image A1 and a right breast image B1 without background artifacts (S310). Image operations unit 121 next selects a floating image from among the left and right breast images A1 and B1 (S313). The floating image will be translated from its original position until a measure of similarity is optimized, as further described at FIG. 5. In one exemplary implementation, the smaller image among the left and right breast images A1 and B1 is picked as the floating image. The image not picked as floating image is called the fixed image herein.

Suppose that A1 is the floating image and B1 is the fixed image. Image operations unit 121 flips the floating image A1, so that it has an orientation similar to the other breast image B1 (S316). Image operations unit 121 hence obtains a flipped floating image A2 (S316). The flipped floating image A2 may, for example, show the breast tip on the same side of the image as the fixed image B1.

Image operations unit 121 down samples the flipped floating image A2 to obtain a flipped, down-sampled floating image A3 (S319). Image operations unit 121 next pads the flipped, down-sampled floating image A3, to obtain a padded flipped down-sampled floating image A4 (S322). To obtain a padded image, width or height of an image is/are increased, to enable image translation. New information is not added to the breast image. The additional rows (or columns) in the padded image may be assigned an intensity value of ‘0’, which is similar to the intensity of masked background pixels. In a preferred embodiment, the floating image is padded to increase its height. The padding step S322 may be omitted, when there is no need to change the width or height of a breast image.

Image operations unit 121 sends the fixed image B1 and the padded flipped down-sampled floating image A4, or the flipped, down-sampled floating image A3 if no padding is performed, to image similarity unit 131 (S330).

FIG. 5 is a flow diagram illustrating operations performed by an image similarity unit 131 included in an image processing unit 37 for image alignment according to an embodiment of the present invention illustrated in FIG. 2. The flow diagram in FIG. 5 illustrates exemplary details of steps S206 and S209 from FIG. 3.

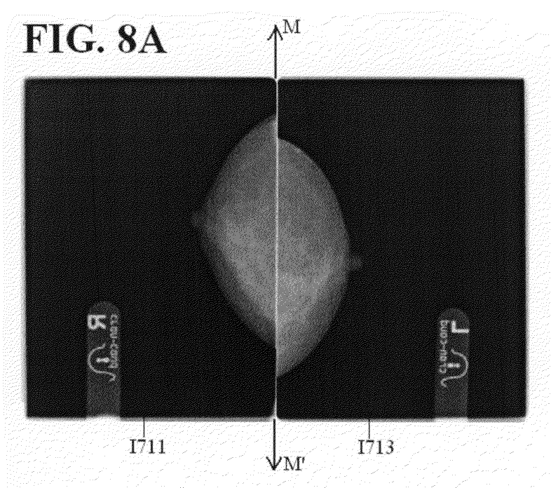

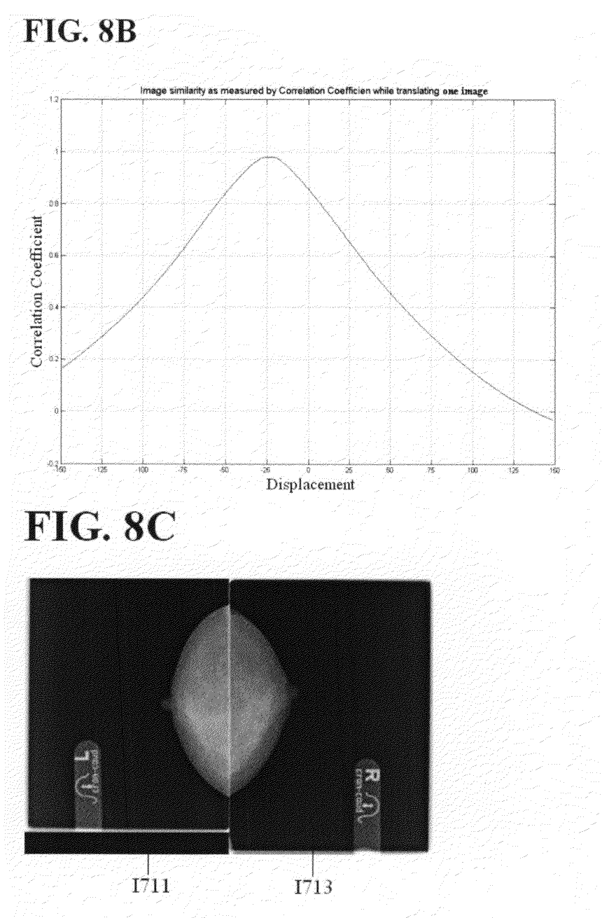

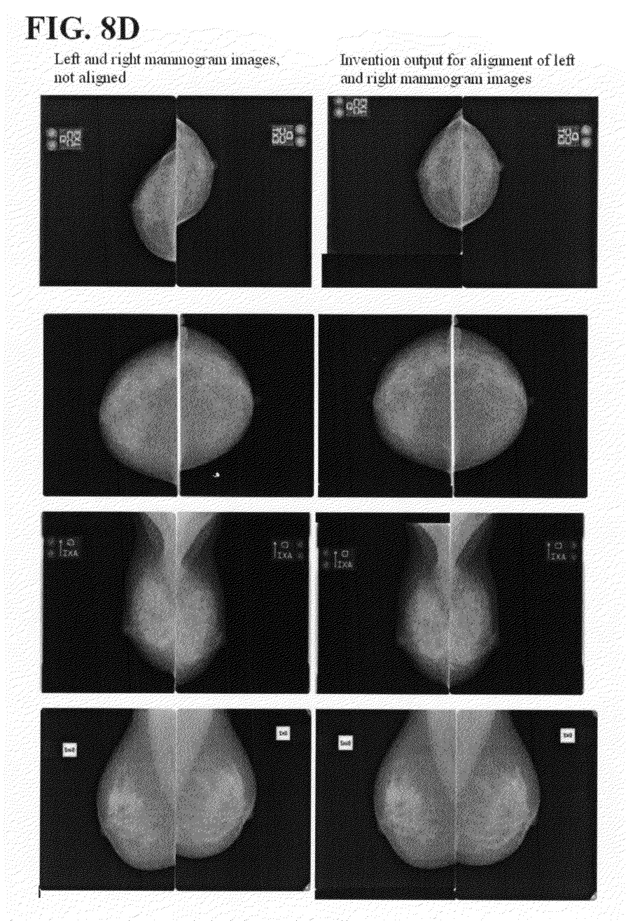

Image similarity unit 131 receives from image operations unit 121 the fixed image B1 and the padded floating image A4, or the flipped, down-sampled floating image A3 if no padding was performed (S401). Image similarity unit 131 may perform image registration in a 1-dimensional translation space. For this purpose, the floating image A4 (or A3) is translated from its original position (S403), to obtain a translated floating image. The floating image can be translated along any direction with respect to the fixed image. In an exemplary embodiment, the floating image is translated along a vertical breast line (such as line MM′ in FIG. 8A) with respect to the fixed image.

A similarity measure between the translated floating image and the fixed image is calculated (S405). Steps S403 and S405 may be repeated multiple times (N times), and a vector of image similarity is generated (S407). The vector includes similarity measures between images, for various relative positions of the images. An optimized value for the image similarity measure is extracted from the vector of image similarity (S411). The optimized image similarity value determines the alignment position for the floating and fixed images (S412). Alignment information corresponding to the optimum image similarity value is sent to image alignment unit 141.

Any measure of similarity can be used in step S405. In exemplary embodiments, the cross-correlation measure, or the mutual information measure, is calculated in step S405. For some measures of similarity, the optimized value extracted at step S411 is the maximum value. For other measures of similarity, the optimized value extracted at step S411 may be other types of values, such as the minimum value, etc. Multiple measures of similarity may also be used in step S405.

A cross-correlation measure calculates a correlation coefficient between two images. The correlation coefficient can be used to measure similarity between floating and fixed images when the floating image is translated, because of relative similarity in image intensities of the left and right mammogram views. The correlation coefficient is given by formula (1):

$${ρ}_{X , Y} = \frac{\text{cov} ( X , Y )}{{σ}_{X} {σ}_{Y}} , \qquad ( 1 )$$

where X represents an intensity matrix associated with the first image, and Y represents an intensity matrix associated with the second image.

When the left and right breast images are aligned, the left and right breast images share an approximately linear relationship between their respective intensities. When one of the images is moved with respect to the other image, due to human positioning errors for example, the linear relationship between image intensities degrades. Since pixel intensities in the floating image are linearly related to pixel intensities in the fixed image, the correlation coefficient is high when the floating and fixed images are aligned, and low when the images are misaligned.

In exemplary implementations, the correlation coefficient is computed in the pixel intensity space via the Fourier transform (FT). One advantage of the FT approach is faster computation of the correlation coefficient for relative translations of floating image with respect to the fixed image.

In an alternative embodiment, a mutual information measure is used in step S405. For two random variables X and Y, the mutual information between X and Y is given by formula (2):

$${MI}_{X , Y} = {\sum }_{y = 0}^{M} {\sum }_{x = 0}^{R} f ( x , y ) log \frac{f ( x , y )}{f ( x ) f ( y )} \qquad ( 2 )$$

where f(x, y) is the joint probability density of variables X and Y, f (x) is the marginal probability density of X, and f(y) is the marginal probability density of Y. In formula (2), X and Y represent the fixed and floating images. X and Y may be 2D arrays of pixel intensities. The mutual information between X and Y is maximized when the two images corresponding to X and Y are aligned. With image alignment, variable X provides maximum information about variable Y.

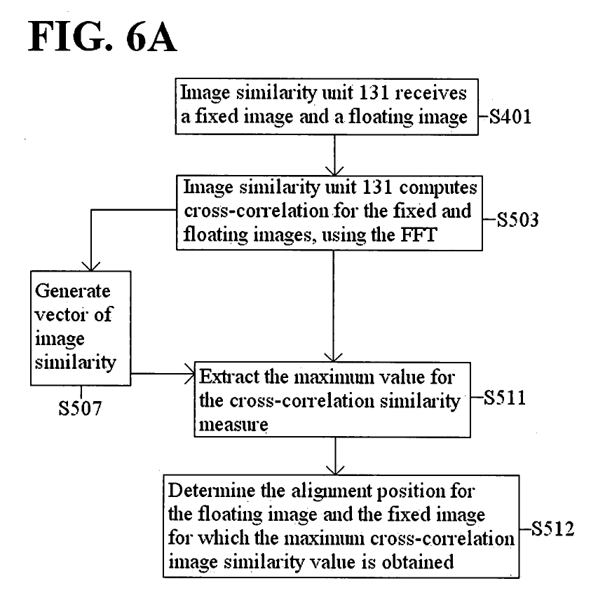

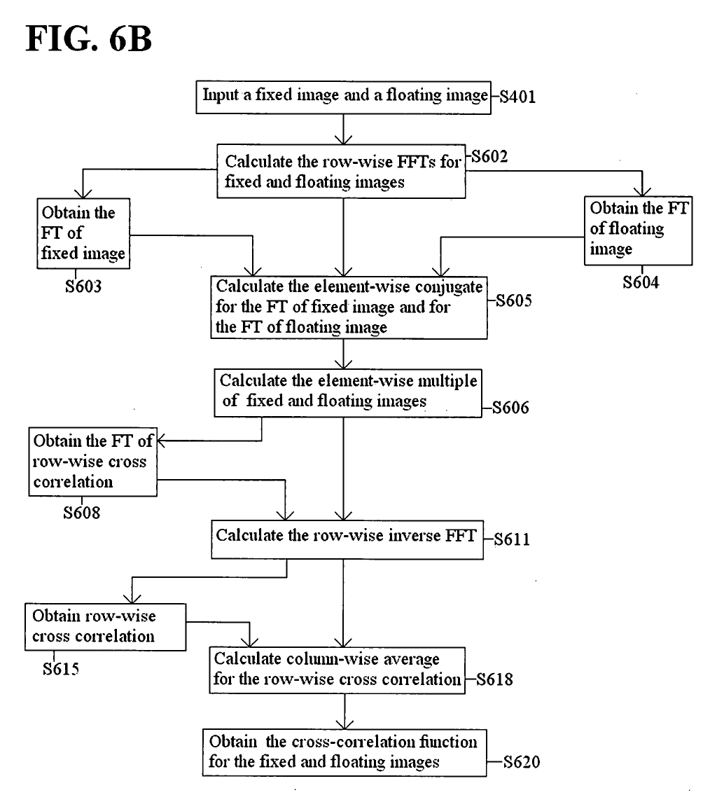

FIG. 6A is a flow diagram illustrating operations performed by an image similarity unit 131 using cross-correlation calculated via the Fast Fourier Transform (FFT) according to an embodiment of the present invention illustrated in FIG. 5. FIG. 6B is a flow diagram illustrating details of operations performed by an image similarity unit 131 using cross-correlation calculated via the FFT according to an embodiment of the present invention illustrated in FIG. 5.

The cross-correlation function can be efficiently calculated using the Fast Fourier Transform (FFT). Detail of proof of equivalency for FFT and cross-correlation function can found in “Discrete-Time Signal Processing”, by A. Oppenheim et al., 2^{nd} Edition, Chapter 7, Prentice Hall.

As illustrated in FIG. 6A, image similarity unit 131 receives a fixed image and a floating image (S401). Image similarity unit 131 computes cross-correlation for the fixed and floating images, using the FFT (S503).

A vector of image similarity is generated (S507), and the maximum value for the cross-correlation similarity measure is extracted from the vector of image similarity (S511). The maximum cross-correlation image similarity value determines the alignment position for the floating image and the fixed image (S512). Alignment information corresponding to the maximum cross-correlation image similarity value is sent to image alignment unit 141.

FIG. 6B illustrates details of step S503 in FIG. 6A. As illustrated in FIG. 6B, the row-wise FFTs for the fixed and floating images are calculated (S602). The element-wise conjugate for the FT of the fixed image and for the FT of the floating image are calculated (S605). Element-wise conjugate is performed by inverting the sign of imaginary part of each complex valued element. The element-wise multiple of the conjugated images is next obtained (S606). The FT of the row-wise cross-correlation for fixed and floating images is thus obtained (S608). The row-wise inverse FFT of the FT of the row-wise cross-correlation is next calculated (S611), and the row-wise cross correlation for images is obtained (S615). The row-wise cross correlation may be a row vector. By calculating the column-wise average for the row-wise cross-correlation (S618), the cross-correlation function for the fixed and floating images is obtained (S620).

Other transform techniques, such as the simple Fourier Transform, may be used instead of the FFT, to calculate cross-correlation.

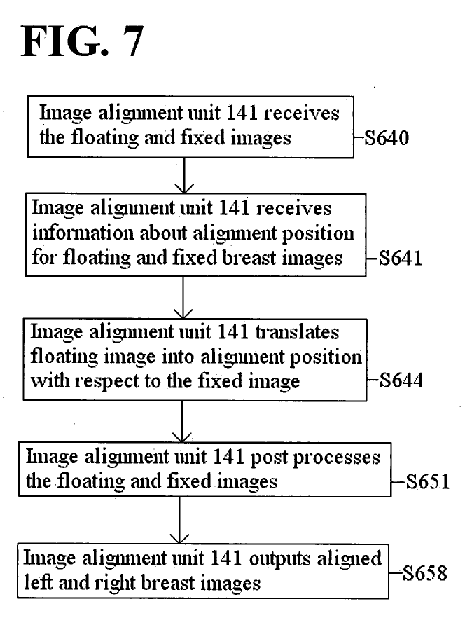

FIG. 7 is a flow diagram illustrating operations performed by an image alignment unit 141 included in an image processing unit 37 for image alignment according to an embodiment of the present invention illustrated in FIG. 2. The flow diagram in FIG. 7 illustrates exemplary details of step S211 from FIG. 3.

Image alignment unit 141 receives the fixed and floating breast images (S640). Image alignment unit 141 also receives information about the alignment position for the fixed and floating breast images, from image similarity unit 131 (S641). Image alignment unit 141 then translates the floating image into alignment position with respect to the fixed image (S644). Image alignment unit 141 may also post-process the floating and fixed images (S651). Image alignment unit 141 may, for example, supersample the floating and fixed images to bring them to original resolution, perform color correction for the breast images, etc. Image alignment unit 141 outputs aligned left and right breast images (S658).

FIG. 8A illustrates a pair of exemplary left and right mammogram images not aligned to each other, and FIG. 8B illustrates the correlation coefficient for the images in FIG. 8A, for various relative displacements between the images according to an embodiment of the present invention illustrated in FIG. 5. FIG. 8C illustrates the left and right mammogram images from FIG. 8A aligned to each other, to maximize the correlation coefficient illustrated in FIG. 8B. FIG. 8A illustrates two CC mammograms for the left and right breast views CCL and CCR. The correlation coefficient for the left and right images positioned as shown in FIG. 8A, is 0.82. One of the images is next translated with respect to the other and the resultant correlation coefficient is calculated for each relative displacement of the images. FIG. 8B illustrates the correlation coefficient vs. relative displacement between images. The plot in FIG. 8B indicates that the floating image needs to be translated to maximize the correlation coefficient.

FIG. 8D illustrates exemplary alignment results for left and right mammogram images according to an embodiment of the present invention illustrated in FIG. 2. Unaligned left and right mammogram images are illustrated in the left column. Alignment results for the mammogram images using methods described in the current invention are illustrated in the right column.

Methods and apparatuses of the present invention may also be used to align images of the same breast, where the images were taken at different times. For example, images of a breast, taken over a few years, can be aligned using methods and apparatuses of the current invention, to observe breast shape evolution.

Methods and apparatuses of the present invention perform displacement of breast images to improve visualization of mammograms on digital workstations, and thus to help medical specialists effectively compare breast views. The techniques described in the present invention can align pairs of mammography images irrespective of pose (CC pairs, ML pairs, etc.); do not need information from ancillary features such as nipple or pectoral muscles; and are not affected by image noise, artifacts, lead-markers, pacemakers or implants.

Although detailed embodiments and implementations of the present invention have been described above, it should be apparent that various modifications are possible without departing from the spirit and scope of the present invention.

We claim:

1. An image processing method, said method comprising:
accessing digital image data representing a first breast image including a left breast, and a second breast image including a right breast;
removing from said first and second breast images artifacts not related to said left and right breasts; and
aligning said left and right breasts using a similarity measure between said first and second breast images, said similarity measure depending on a relative position of said first and second breast images.

2. The image processing method as recited in claim 1, wherein said similarity measure is a correlation coefficient between said first and second breast images.

3. The image processing method as recited in claim 1, wherein said similarity measure is the mutual information between said first and second breast images.

4. The image processing method as recited in claim 1, wherein said similarity measure is a cross-correlation function between said first and second breast images, said cross-correlation function being calculated with the Fast Fourier Transform.

5. The image processing method as recited in claim 1, wherein said aligning step includes
translating said first breast image with respect to said second breast image,
calculating said similarity measure between said first and second breast images for various translation positions, and
aligning said left and right breasts using a translation position associated with an optimized value for said similarity measure.

6. The image processing method as recited in claim 1, wherein said removing step includes
clustering pixels of said first or second breast image to obtain initial clusters, based on a parameter relating to a spatial characteristic of said pixels in said first or second breast image, a parameter relating to an intensity characteristic of said pixels in said first or second breast image, and a parameter relating to a smoothness characteristic of said pixels in said first or second breast image, and
detecting a cluster associated with said left or right breast, said step of detecting a cluster including
performing cluster merging for said initial clusters using an intensity measure of said initial clusters to obtain final clusters, and
eliminating from said final clusters pixels that do not belong to said left or right breast, to obtain a cluster associated with said left or right breast.

7. The image processing method as recited in claim 1, further comprising:
preprocessing said first and second breast images, by
flipping said first breast image to obtain a flipped image with an image orientation similar to said second breast image,
down-sampling said flipped image, and
padding said down-sampled flipped image to obtain a padded image, wherein said padded image and said second breast image are used by said aligning step.

8. An image processing method, said method comprising:
accessing digital image data representing a first breast image including a left breast, and a second breast image including a right breast;
setting background pixels in said first and second breast images to a substantially uniform pixel intensity value; and
aligning said left and right breasts using a similarity measure between said first and second breast images, said similarity measure depending on a relative position of said first and second breast images.

9. The image processing method as recited in claim 8, wherein said similarity measure is a correlation coefficient between said first and second breast images.

10. The image processing method as recited in claim 8, wherein said similarity measure is the mutual information between said first and second breast images.

11. The image processing method as recited in claim 8, wherein said similarity measure is a cross-correlation function between said first and second breast images, said cross-correlation function being calculated with the Fast Fourier Transform.

12. The image processing method as recited in claim 8, wherein said aligning step includes
translating said first breast image with respect to said second breast image,
calculating said similarity measure between said first and second breast images for various translation positions, and
aligning said left and right breasts using a translation position associated with an optimized value for said similarity measure.

13. The image processing method as recited in claim 8, wherein said step of setting background pixels includes
clustering pixels of said first or second breast image to obtain initial clusters, based on a parameter relating to a spatial characteristic of said pixels in said first or second breast image, and a parameter relating to an intensity characteristic of said pixels in said first or second breast image,
detecting among said initial clusters a background cluster not associated with said left or right breast, and
setting pixels in said background cluster to said substantially uniform pixel intensity value.

14. The image processing method as recited in claim 8, further comprising:
preprocessing said first and second breast images, by
flipping said first breast image to obtain a flipped image with an image orientation similar to said second breast image,
down-sampling said flipped image, and
padding said down-sampled flipped image to obtain a padded image,
wherein said padded image and said second breast image are used by said aligning step.

15. An image processing apparatus, said apparatus comprising:
an image data input unit for accessing digital image data representing a first breast image including a left breast, and a second breast image including a right breast;
an image preprocessing unit for setting background pixels in said first and second breast images to a substantially uniform pixel intensity value; and
an image alignment unit for aligning said left and right breasts using a similarity measure between said first and second breast images, said similarity measure depending on a relative position of said first and second breast images.

16. The apparatus according to claim 15, wherein said similarity measure is a correlation coefficient between said first and second breast images.

17. The apparatus according to claim 15, wherein said similarity measure is the mutual information between said first and second breast images.

18. The apparatus according to claim 15, wherein said similarity measure is a cross-correlation function between said first and second breast images, said cross-correlation function being calculated with the Fast Fourier Transform.

19. The apparatus according to claim 15, wherein said image alignment unit aligns by
translating said first breast image with respect to said second breast image,
calculating said similarity measure between said first and second breast images for various translation positions, and
aligning said left and right breasts using a translation position associated with an optimized value for said similarity measure.

20. The apparatus according to claim 15, wherein said image preprocessing unit sets background pixels by
clustering pixels of said first or second breast image to obtain initial clusters, based on a parameter relating to a spatial characteristic of said pixels in said first or second breast image, and a parameter relating to an intensity characteristic of said pixels in said first or second breast image,
detecting among said initial clusters a background cluster not associated with said left or right breast, and
setting pixels in said background cluster to said substantially uniform pixel intensity value.

21. The apparatus according to claim 15, wherein said image preprocessing unit preprocesses said first and second breast images, by
flipping said first breast image to obtain a flipped image with an image orientation similar to said second breast image,
down-sampling said flipped image, and
padding said down-sampled flipped image to obtain a padded image, wherein said padded image and said second breast image are used by said image alignment unit.
